(19) United States
(12) Patent Application Publication
(10) Pub. No.: US 2025/0344827 A1
(43) Pub. Date: Nov. 13, 2025

(54) HAIRSTYLING APPARATUS WITH RECONFIGURABLE CURRENT FLOWS

(71) Applicant: Dyson Technology Limited, Malmesbury, Wiltshire (GB)

(72) Inventors: Michael James WAITE, Cirencester (GB); Christopher John BATEMAN, Swindon (GB); Stephen GREETHAM, Gloucester (GB); Robert James Kenward MCDOUGALL, Swindon (GB)

(21) Appl. No.: 18/868,541

(22) PCT Filed: May 24, 2023
(86) PCT No.: PCT/GB2023/051362

§ 371 Date: Nov. 22, 2024

(30) Foreign Application Priority Data
May 25, 2022 (GB) 2207675.6
May 24, 2023 (GB) 2307800.9

(51) Int. Cl. A45D 20/30; A45D 1/04; A45D 2/00

(52) U.S. Cl. CPC A45D 20/30; A45D 1/04; A45D 2/001

(57) ABSTRACT

A hairstyling apparatus having heating elements, and a sensor for determining voltage and/or current output of an electrical energy source, and outputting a signal indicative of the determined voltage and or/current output. Switching components are connected with the heating elements. The switching components are controlled to reconfigure current flows through the plurality of heating elements in reliance on the signal.

### FIELD

The present invention relates to a hairstyling apparatus that uses heat, and optionally moving air, to dry and/or style hair.

### BACKGROUND

Hairstyling apparatuses such as hairdryers and hair straighteners use heat to allow styling of a user's hair. For example, a hairdryer heats air that is blown out of a nozzle onto hair to be dried/styled. A hair straightener heats one or more plates, between which a tress of hair is pulled to straighten it.

It is desirable for a hairstyling apparatus to be usable in jurisdictions having different mains voltages. For example, a switch may allow a user to place the hairstyling apparatus into a low voltage (e.g., nominally 120 Vac) or a high voltage (e.g., nominally 230 Vac) mode, depending upon the local mains voltage. It is also desirable improve the operation of a battery-powered hairstyling apparatus in spite of voltage fluctuation or reduction of the electrical energy source during the operation.

### SUMMARY

In accordance with a first aspect of the invention, there is provided a hairstyling apparatus comprising:
a plurality of heating elements;
a sensor for determining a voltage and/or current output of an electrical energy source, and outputting a signal indicative of the determined voltage and/or current output; and
one or more switching components connected with the heating elements;
wherein the hair-styling apparatus is configured such that the one or more switching components are controlled so as to reconfigure current flows through the plurality of heating elements at least partly in reliance on the signal.

By reconfiguring current flows through the heating elements in this manner, the potential for user error in selecting a regional voltage may be reduced or avoided. Furthermore, the efficiency, safety and battery life longevity may be improved in spite of voltage fluctuations or voltage reduction of the electrical energy source during the operation cycle of the energy source.

The sensor is configured to determine a voltage output, a current output or a combination thereof of the electrical energy source and output a signal indicative of the determined voltage and/or current output. This may be advantageous when there is limited information about the actual power being consumed by the hairstyling apparatus. Monitoring the voltage output may provide information about power supply stability and device compatibility while monitoring current output may allow for direct and accurate assessment of power consumption, detection of faults, and implementation of protective measures. Accordingly, a combination of voltage and current output monitoring provides a more comprehensive understanding of the behaviour of the electrical energy source.

The electrical energy source may comprise a mains power supply. Alternatively, or additionally, the electrical energy source may comprise a store of electrical energy. The electrical energy source may be a battery, such as a rechargeable battery. The electrical energy source may be replenishable with electrical energy, such as by being recharged with electrical energy.

When the determined voltage is within a first range of voltage values, the one or more switching components may be controlled such that a total circuit resistance of the heating elements through which current flows is lower than a total circuit resistance of the heating elements through which current flows when the determined voltage exceeds the first range of voltage values.

When the determined voltage is within the first range of voltage values, the one or more switching components may be controlled such that the current flows in parallel through at least a first and a second of the heating elements, thereby to lower the total circuit resistance of the heating elements through which current flows.

When the determined voltage is within the first range of voltage values, the one or more switching components may be controlled such that the current does not flow through at least one of the heating elements other than the first and second heating elements, thereby to lower the total circuit resistance of the heating elements through which current flows.

When the determined voltage is within the first range of voltage values, the one or more switching components may be controlled such that at least one of the heating elements is bypassed, thereby to lower the total circuit resistance of the heating elements through which current flows.

When the determined voltage is within a second range of voltage values, the one or more switching components may be controlled such that a total circuit resistance of the heating elements through which current flows is higher than a total circuit resistance of the heating elements through which current flows when the determined voltage is lower than the second range of voltage values.

When the determined voltage is within the second range of voltage values, the one or more switching components may be controlled such that the current flows in series through at least a third and fourth of the heating elements, thereby to increase the total circuit resistance of the heating elements through which current flows. The third and fourth heating elements may be the first and second heating elements, or either or both of the third and fourth heating elements may be additional to the first and second heating elements.

There may also be one or more additional heating elements, connected in series and/or parallel with any one or more of the first, second, third, and/or fourth heating elements, or combinations thereof.

When the determined voltage is within the second range of voltage values, the one or more switching components may be controlled such that the current flows through at least one of the heating elements through which current does not flow when the determined voltage is outside the second range of voltage values.

When the determined voltage is within the second range of voltage values, the one or more switching components may be controlled such that current flows through at least one of the heating elements through which current does not flow when the determined voltage is lower than the second range of voltage values.

At least a plurality of the heating elements may be connected in parallel with each other, each parallel connected heating component being controllable by at least one of the switching components, the hair-styling apparatus being configured such that the one or more switching components are controlled, responsive to the signal, so as to configure current flow through:
a first set of the heating elements; or
a second set of the heating elements different to the first set.

The first set of heating elements may comprise one or more of the heating elements of the second set of heating elements.

The switching components may comprise one or more power semiconductor devices, one or more TRIACS, and/or one or more relays.

One or more of the switching components may be connected in series with at least one of the heating elements.

The hairstyling apparatus may comprise a heater wherein the heater comprises the plurality of heating elements. In a further example, the hairstyling apparatus may comprise a plurality of heaters wherein each of the heaters comprises a respective plurality of heating elements. In an embodiment comprising the plurality of heaters, each of the plurality of heaters may be controlled independently of one another. For example, in an embodiment, the hairstyling apparatus may comprise a first heater and a second heater each heater comprising a respective plurality of heating elements and the hairstyling apparatus is configured such that the first heater is controllable independently of the second heater. By controlling each of the plurality of heaters independently, the hairstyling apparatus provides increased flexibility and versatility in use.

In an embodiment wherein the hairstyling apparatus comprises a first heater and a second heater each heater comprising a respective plurality of heating elements, the hairstyling apparatus may be configurable such that the one or more switching components are controlled so as to reconfigure current flows through the plurality of heating elements such that the power delivered to the first heater is different to the power delivered to the second heater. By delivering different power to the first heater and the second heater, the hairstyling apparatus provides increased flexibility and versatility in use.

In an embodiment, the hairstyling apparatus may be reconfigurable such that a total circuit resistance of the heating elements of the first heater through which current flows is different to a total circuit resistance of heating elements of the second heater. In a further embodiment, the hairstyling apparatus may be configurable such that the one or more switching components are controlled such that the current flows in parallel through at least a first and a second heating elements of one of the first or second heater, while the current flows in series through at least a first and a second heating elements of the other of the first or second heater. By configuring the respective heating elements of the first heater and the second heater in this manner, the hairstyling apparatus provides increased flexibility and versatility in use. Furthermore, this allows the heaters of the hairstyling apparatus to be controlled at different power levels under common duty cycle of the pulse-width modulation, reducing the number of components and complexity of the circuit design.

In an embodiment, at least two of the plurality of heating elements may be connected to the switching components via a shared electrical connection. This provides the advantage of reducing the number of junctions and cabling needed therefore reducing the total power loss in the circuit. In battery powered applications, this also increases the runtime. With the reduction of the power loss, the control signal can operate the switching components in conducting state for longer periods of time and with relatively lower peak currents when compared with an equivalent circuit design where the first heating element and second heating element do not share an electrical connection. Accordingly, the circuit design can be further simplified without any compromise and with fewer connectors, more effective use of available circuit space, reduced cost on manufacturing as well as assembly.

The hairstyling apparatus may comprise a controller connected to control the one or more switching components, wherein the controller is configured to receive the signal from the sensor.

The energy source may comprise a single cell. The energy source may comprise a plurality of cells, wherein the cells are interconnected, and the cells may be connected in series, parallel or a combination thereof. Each cell may be lithium-ion cell. Energy source may be a solid polymer battery pack.

The hairstyling apparatus may comprise a housing and the electrical energy source may be located within the housing. Providing the electrical energy source within the housing, removes requirement for an external electrical power supply that would undesirably make the hairstyling apparatus cumbersome and awkward to use.

The hairstyling apparatus may comprise an electrical connector, the electrical connector connectable to an external electrical energy supply to facilitate recharging of the electrical energy source.

The hair styling apparatus may comprise a charging circuit to control the flow of electrical energy from the electrical connector to the electrical energy source to recharge the electrical energy source.

When the electrical energy source is rechargeable through the electrical connector, there is no need to provide an external cable to power the heater or heaters of the hairstyling apparatus. This makes the hairstyling apparatus of the present invention less cumbersome and awkward to use. The hairstyling apparatus may therefore be more comfortable for a user to operate.

The electrical energy source may comprise a lithium-ion battery. The battery may provide a voltage of 2.65V or higher. The battery may provide a voltage of 50 V or less. In some embodiments the battery may provide a voltage of 26 V or less. In some embodiments the battery may provide a voltage of 17 V or less. The battery may have a capacity of at least 700 mAh. The battery may have a capacity of at least 1000 mAh. The battery may have a capacity of less than 40000 mAh. In some embodiments the battery may have a capacity of less than 25000 mAh. The battery may have a high continuous discharge of current of up to 40 A. In a further example, the battery may have a continuous discharge rate of up to 25 A. In a further example the battery may have a continuous discharge rate of up to 10 A. The battery may deliver continuous power in the range of 0.5 W and 350 W.

The hairstyling apparatus may comprise a processor to control the supply of electrical energy to the plurality of heating elements from the electrical energy source.

When the electrical energy source is a battery, the potential issue related to managing the variation in battery cell voltage may arise. This variation may be a decrease in the battery cell voltage during operation of the hairstyling apparatus. For example, in one embodiment, voltage of a cell may change between 4.2 VDC when fully charged and 2.65 VDC when fully discharged. The present invention provides a hairstyling apparatus capable of maintaining acceptable performance at low battery cell voltage while avoiding excessive currents at high battery cell voltage. This may also improve the batter cell life longevity.

Advantageously, thermal protection components with lower rated peak current values may be chosen for the control circuit. Heating elements may be controlled by pulse-width modulation (PWM) which in turn pulse-width modulates the current flowing through the heating elements. Because the thermal protection components monitor the current drawn from the energy source, the amplitude of the current passing through the heating elements becomes an important parameter for choosing the appropriate thermal protection component. The pulsed nature of the power regulation can also generate electromagnetic interference. The proposed reconfiguration of the switching components may limit the peak currents flowing through the heaters whilst maintaining the operation of the hairstyling apparatus despite the variation in energy source voltage. Limiting the peak currents is also advantageous for choosing cheaper and simpler components, as this enables use of components that are rated for lower peak currents and electromagnetic interference.

According to a second aspect of the present invention there is provided a hairstyling apparatus kit comprising at least one hairstyling apparatus according to the first aspect of the invention and a hairstyling apparatus charging device to charge the hairstyling apparatus. The charging device is configured to deliver electrical energy to the hairstyling apparatus to recharge the electrical energy source.

There is also provided a hairstyling apparatus comprising:
a first heater, a second heater, each of the heaters comprising a respective plurality of heating elements;
one or more switching components connected with the heating elements;
wherein the hair-styling apparatus is configured such that the one or more switching components are controlled so as to reconfigure current flows through the plurality of heating elements such that the power delivered to the first heater is different to the power delivered to the second heater.

The switching components of the hairstyling apparatus may be further reconfigured such that a total circuit resistance of the heating elements of the first heater through which current flows is different to a total circuit resistance of heating elements of the second heater.

The switching components for one or both of first and second heater may be reconfigured such that the current flows in parallel through at least a first and a second of the heating elements, thereby to lower the total circuit resistance of the first heating elements through which current flows.

The switching components for one or both of first and second heater may be reconfigured such that the current flows in series through at least a first and a second of the heating elements, thereby to increase the total circuit resistance of the heating elements through which current flows.

The switching components of the hairstyling apparatus may be further reconfigured such that the current flows in parallel through at least a first and a second of the heating elements of one of the first or second heater, while the current flows in series through at least a first and a second heating elements of the other of the first or second heater.

The switching components may be controlled via a user interface. This enables selective operation of the heaters based on user preference or application type. The switching components may be controlled via a controller comprising a set of machine-readable instructions. The machine-readable instructions, which when executed by the controller, may reconfigure the hairstyling apparatus to perform such that the one or more switching components are controlled so as to reconfigure current flows through the plurality of heating elements such that the power supplied to the first heater is different to the power supplied to the second heater.

There is also provided a method of controlling a hairstyling apparatus, the hairstyling apparatus comprising:
a plurality of heating elements;
a sensor for determining a voltage and/or current output of an electrical energy source, and outputting a signal indicative of the determined voltage and/or current; and
one or more switching components connected with the heating elements;
the method comprising controlling the one or more switching components so as to reconfigure current flows through the plurality of heating elements at least partly in reliance on the signal.

When the determined voltage is within a first range of voltage values, the method may comprise controlling the one or more switching components such that a total circuit resistance of the heating elements through which current flows is lower than a total circuit resistance of the heating elements through which current flows when the determined voltage exceeds the first range of voltage values.

When the determined voltage is within the first range of voltage values, the method may comprise controlling the one or more switching components such that the current flows in parallel through at least a first and second the heating elements, thereby to lower the total circuit resistance of the heating elements through which current flows.

When the determined voltage is within the first range of voltage values, the method may comprise controlling the one or more switching components such that the current does not flow through at least one of the heating elements other than the first and second heating elements, thereby to lower the total circuit resistance of the heating elements through which current flows.

When the determined voltage is within the first range of voltage values, the method may comprise controlling the one or more switching components such that at least one of the heating elements is bypassed, thereby to lower the total circuit resistance of the heating elements through which current flows.

When the determined voltage is within a second range of voltage values, the method may comprise controlling the one or more switching components such that a total circuit resistance of the heating elements through which current flows is higher than a total circuit resistance of the heating elements through which current flows when the determined voltage is lower than the second range of voltage values.

When the determined voltage is within the second range of voltage values, the method may comprise controlling the one or more switching components such that the current flows in series through at least a third and fourth of the heating elements, thereby to increase the total circuit resistance of the heating elements through which current flows.

When the determined voltage is within the second range of voltage values, the method may comprise controlling the one or more switching components such that the current flows through at least one of the heating elements through which current does not flow when the determined voltage is outside the second range of voltage values.

At least a plurality of the heating elements may be connected in parallel with each other, each parallel connected heating component being controllable by at least one of the switching components, and the method may comprise controlling, responsive to the signal, the switching elements so as to configure current flow through:
a first set of the heating elements; or
a second set of the heating elements different to the first set.

When the hairstyling apparatus comprises a first heater comprising a plurality of heating elements and a second heater comprising a plurality of heating elements, the method may further comprise controlling the first heater independently of the second heater.

When the hairstyling apparatus comprises a first heater comprising a plurality of heating elements and a second heater comprising a plurality of heating elements, the method may comprise controlling one or more switching components of the hairstyling apparatus so as to reconfigure current flows through the plurality of heating elements such that the power delivered to the first heater is different to the power delivered to the second heater.

When the hairstyling apparatus comprises a first heater comprising a plurality of heating elements and a second heater comprising a plurality of heating elements, the method may comprise controlling the switching components of the hairstyling apparatus such that a total circuit resistance of the heating elements of the first heater through which current flows is different to a total circuit resistance of heating elements of the second heater.

When the hairstyling apparatus comprises a first heater comprising a plurality of heating elements and a second heater comprising a plurality of heating elements, the method may comprise controlling the switching components so as to reconfigure one or both of first and second heater such that the current flows in parallel through at least a first and a second of the heating elements, thereby to lower the total circuit resistance of the first heating elements through which current flows.

When the hairstyling apparatus comprises a first heater comprising a plurality of heating elements and a second heater comprising a plurality of heating elements, the method may comprise controlling the switching components so as to reconfigure one or both of first and second heater such that the current flows in series through at least a first and a second of the heating elements, thereby to increase the total circuit resistance of the heating elements through which current flows.

When the hairstyling apparatus comprises a first heater comprising a plurality of heating elements and a second heater comprising a plurality of heating elements, the method may comprise controlling the switching components so as to reconfigure hairstyling apparatus such that the current flows in parallel through at least a first and a second of the heating elements of one of the first or second heater, while the current flows in series through at least a first and a second heating elements of the other of the first or second heater.

Optional features of aspects of the present invention may be equally applied to other aspects of the invention, where appropriate.

### BRIEF DESCRIPTION OF DRAWINGS

In order that the present invention may be more readily understood, embodiments of the invention will now be described, by way of example, with reference to the accompanying drawings, in which:

FIG. 1 is a schematic longitudinal section through a hair straightener;

FIG. 2 is a plan view of a heater for the hair straightener of FIG. 1;

FIGS. 3 to 5 show a circuit comprising heating elements;

FIGS. 6 to 8 show a further circuit comprising heating elements;

FIGS. 9 to 11 show yet a further circuit comprising heating elements;

FIG. 12 shows yet a further circuit comprising heating elements;

FIG. 13 shows yet a further circuit comprising heating elements;

FIG. 14 shows a method of controlling a hairstyling apparatus; and

FIGS. 15 to 20 show yet a further circuit comprising heating elements.

### DETAILED DESCRIPTION

The present application relates to a hairstyling apparatus, such as a hair dryer, hair straightener, curling wand, or any other such apparatus used for styling hair with heat (and optionally steam, ultrasonic mist, and/or moving air).

The hairstyling apparatus includes a plurality of heating elements for generating the heat used to style hair when the apparatus is in use. The apparatus also includes a sensor that is configured to determine the voltage of an electrical energy source or a mains power supply when the apparatus is turned on or plugged in, and to output a signal indicative of the determined voltage and/or current output.

One or more switching components are connected with the heating elements. The switching components are controlled so as to reconfigure current flows through the plurality of heating elements at least partly in reliance on the signal.

The reconfiguring of the current flows can be achieved in several ways. For example, one or more of the heating elements can be switched in to the heating circuit, either in series or parallel with one or more other heating elements. Alternatively, or in addition, one or more of the heating elements can be switched out of the heating circuit. The one or more heating elements can be switched out by being bypassed, or by being turned off. The net resistance of the circuit formed by the heating elements may be changed as a result of the current reconfiguration.

The hairstyling apparatus may be configured such that it can automatically operate at different mains supply voltages, without the need for user intervention. For example, two common mains voltage standards are the nominally 120 Vac standard (used in, for example, North America) and the nominally 230 Vac standard (used in, for example, Europe). The hairstyling apparatus may be configured to operate correctly under both the 120 Vac standard and the 230 Vac standard. The hairstyling apparatus may also be configured such that the electrical connections of the heater elements can be reconfigured automatically and operate reliably with the fluctuating or reducing electrical energy source voltages.

The hairstyling apparatus may operate on the basis of identifying at least two different ranges of voltage values, and reconfiguring the current flow depending upon the range within which the determined voltage lies.

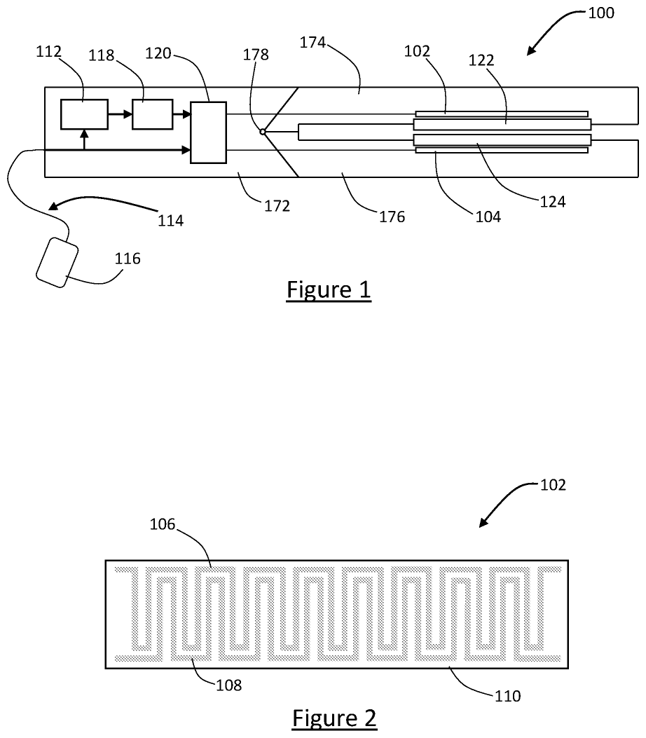

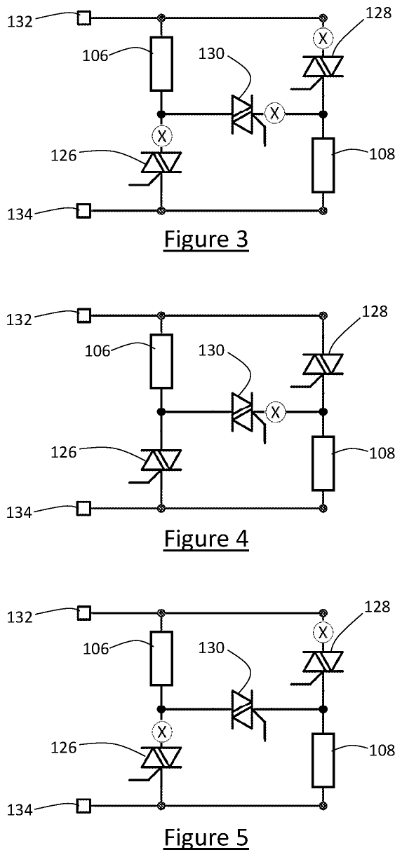

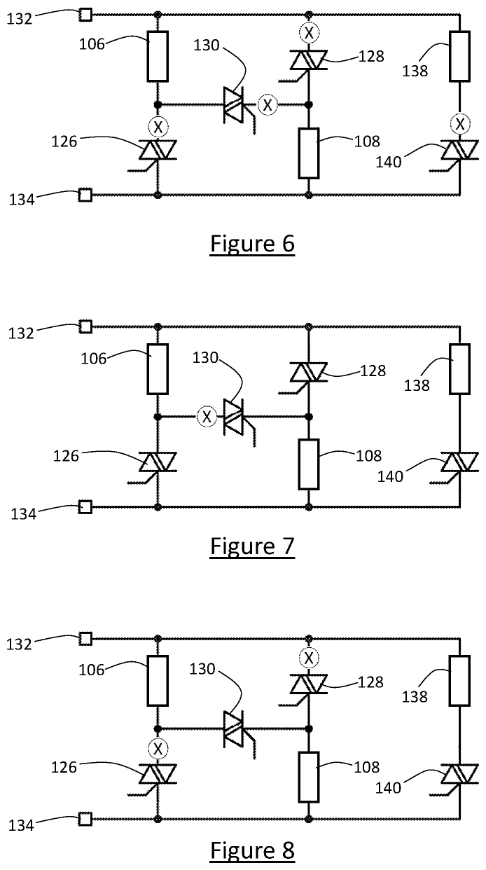

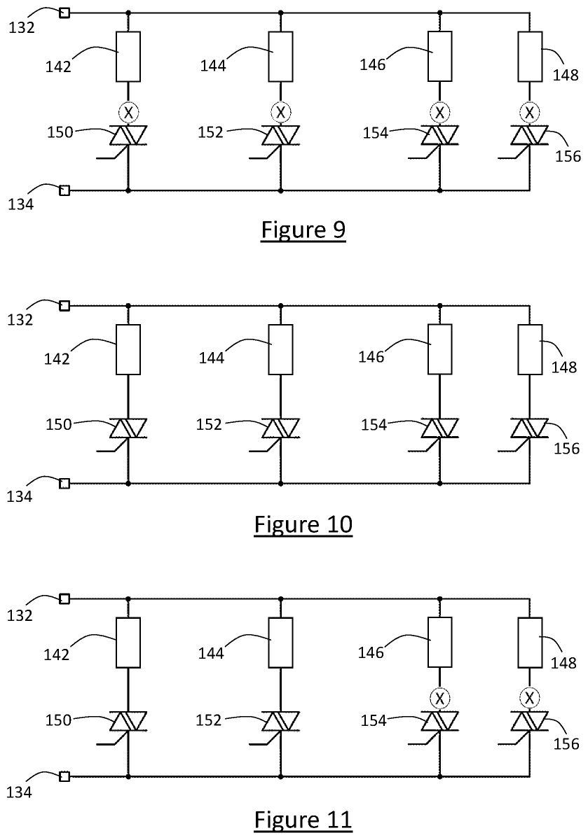

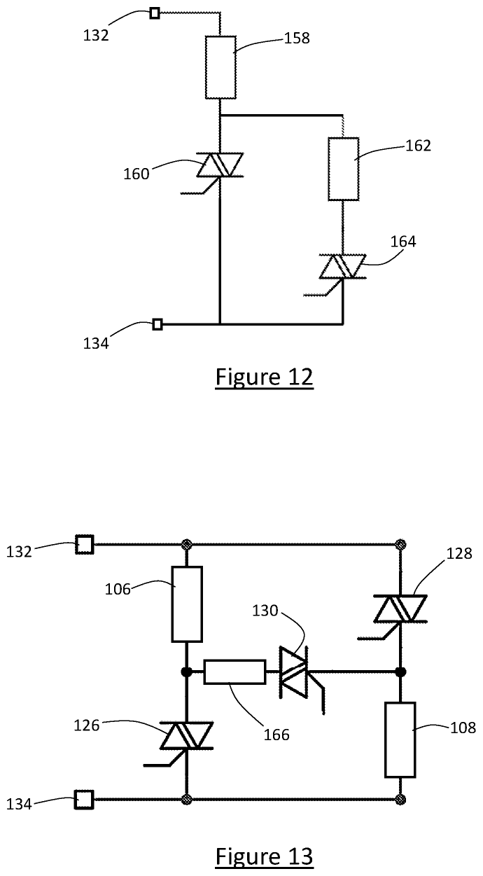

Referring to FIG. 1 there is shown a hairstyling apparatus in the form of a hair straightener 100. Hair straightener 100 comprises a handle 172. A first arm 174 and a second arm 176 are connected to handle 172 at a hinge 178, such that the arms can pivot away from each other.

First arm 174 includes a first hair contact plate 122 and second arm 176 includes a second hair contact plate 124. First plate 122 and second plate 124 are formed from a heat-conductive material, and may include a low-friction coating.

A spring (not shown) biases the arms away from each other, such that a user can position a tress of hair (not shown) between first plate 122 and second plate 124, and then squeeze first and second arms 174 and 176 together to capture the tress of hair between first plate 122 and second plate 124.

Hair straightener 100 comprises a first heater 102 and a second heater 104. As shown in FIG. 2, first heater 102 comprises a plurality of heating elements in the form of a first heating element 106 and a second heating element 108. First heating element 106 and second heating element 108 take the form of electrically resistive traces formed on a substrate 110. Substrate 110 can take the form of, for example, a heat-resistant ceramic plate. First heating element 106 and second heating element 108 are castellated in plan, and interleaved with each other. Other shapes, including sinusoids for example, may also be used.

Second heater 104 comprises heating elements in a similar arrangement to those of first and second heating elements 106 and 108, and will not be described in more detail.

Any other suitable arrangement or configuration of the heating elements may be used. For example, the heating elements may be stacked, with an electrically insulating layer (such as the ceramic substrate) between them. Each heating element may be made up by more than one trace, connected in any suitable parallel and/or series combination.

First heater 102 and second heater 104 are in close proximity with hair contact plates 122 and 124, such that when first heater 102 and second heater 104 are heated, they cause corresponding hair contact plates 122 and 124 to heat up. The interleaving of first heating element 106 and second heating element 108 is such that, irrespective of which of first heating element 106 and/or the second heating element 108 is being heated, heat is transferred to a significant width of hair contact plates 122 and 124. Once hair contact plates 122 and 124 are sufficiently hot, hair straightener 100 can be used to straighten and style hair, as understood by the skilled person.

Hair straightener 100 also includes a sensor in the form of a voltage sensor 112, which is connected to sense a voltage of an onboard electrical energy source or an incoming mains power supply. The mains power supply is supplied to hair straightener 100 by way of a power cord 114 that terminates at a mains plug 116, which is configured to be plugged into a mains voltage socket. Voltage sensor 112 is configured to output a signal in the form of a voltage signal, indicative of the determined voltage, to a controller 118.

Hair straightener 100 comprises a heater driver 120 comprising several switching components. The switching components in hair straightener 100 take the form of TRIACs, which are connected with the first and second heating elements 106 and 108, as described in more detail with reference to FIGS. 3 to 5. Alternatively, for example if the heating elements are supplied with DC power supply, the switching components in hair straightener 100 may take the form of IGBTs, field effect transistors or the like.

Voltage sensor 112, controller 118, and heater driver 120 are shown within handle 172. However, the skilled person will appreciate that these components can be disposed elsewhere in different implementations. For example, one or more of these components may be disposed in a separate housing (not shown) that is connected to hair straightener 100 by a flexible cable that carries power and/or control signals to hair straightener 100. In other implementations that include a fan (not shown) or other motor-driven component, a motor driver (not shown) can similarly be disposed within such a separate housing.

Hair straightener 100 is configured such that the switching components such as TRIACs or IGBTs are controlled so as to reconfigure current flows through the first and second heating elements 106 and 108, at least partly in reliance on the voltage signal.

FIGS. 3 to 5 show a schematic diagram of first heating element 106, second heating element 108, and switching components in the form of a first TRIAC 126, a second TRIAC 128, and a third TRIAC 130. The heating elements in second heater 104 are arranged and operated similarly, and so will not be described in detail.

First heating element 106 and first TRIAC 126 are connected in series between a live terminal 132 and a neutral terminal 134. Second TRIAC 128 and second heating element 108 are connected in series between live terminal 132 and neutral terminal 134. Third TRIAC 130 is connected between a junction between first heating element 106 and first TRIAC 126, and a junction between second TRIAC 128 and second heating element 108.

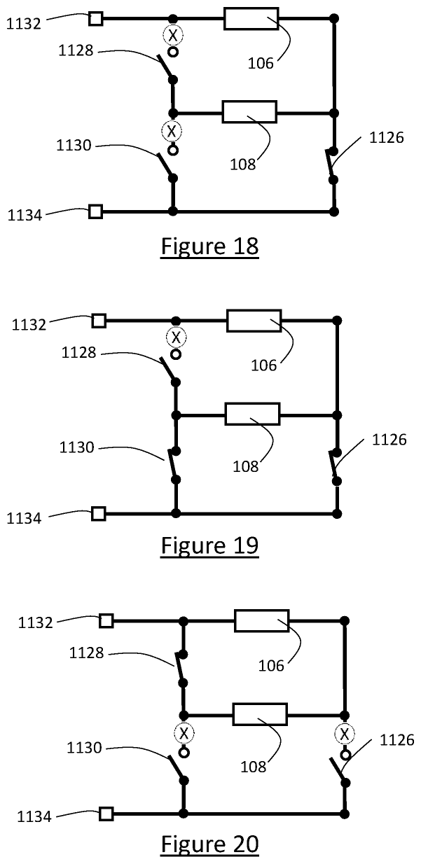

FIGS. 15 to 20 show a schematic diagram of first heating element 106, second heating element 108, and switching components in the form of a first switch 1126, a second switch 1128, and a third switch 1130. The heating elements in second heater 104 are arranged and operated similarly, and so will not be described in detail.

In the alternative arrangement as shown in FIGS. 15 to 20, second switch 1128 and third switch 1130 are connected in series between a first terminal 1132 and a second terminal 1134. First heating element 106 and first switch 1126 are connected in series between the first terminal 1132 and the second terminal 1134. Second heating element 108 is connected between a junction between second switch 1128 and third switch 1130, and a junction between first heating element 106 and first switch 1126. Accordingly, the first heating element 106 and the second heating element 108 share an electrical connection without any junctions or switching components in between. All the operational states described hereinafter in relation to TRIACs 126, 128, 130 and terminals 132, 134 are also applicable for switches 1126, 1128, 1130 and terminals 1132, 1134 respectively.

The arrangement as shown in FIGS. 15 to 20 may be particularly advantageous because by configuring the first heating element 106 and second heating element 108 with a shared electrical connection this reduces the number of junctions and cabling needed, therefore reducing the total power loss as well as the cost of components and assembly. With the reduction of the power loss, the control signal can operate the switching components in a conducting state for longer periods of time and with relatively lower peak currents when compared with an equivalent circuit design where the first heating element 106 and second heating element 108 do not share an electrical connection. Accordingly, the circuit design can be further simplified without compromising on performance and enabling use of fewer connectors, more effective use of available circuit space, and reduced cost on manufacturing as well as assembly.

In addition to the arrangements shown in FIGS. 15 to 17 which are operationally equivalent to the arrangements shown in FIGS. 3 to 5, there are further arrangements as shown in FIGS. 18 to 20 which provide alternative operational states.

Control terminals of first TRIAC 126, second TRIAC 128, and third TRIAC 130 are connected to controller 118. As described in more detail below, controller 118 provides control signals to first TRIAC 126, second TRIAC 128, and third TRIAC 130 in order to reconfigure current flows through the TRIACs, and hence through first heating element 106 and second heating element 108.

Mains plug 116 may be plugged into a mains voltage socket (not shown). When hair straightener 100 is turned on or placed into a standby mode, voltage sensor 112 determines a voltage of the mains power supply and outputs a corresponding voltage signal to controller 118.

The voltage signal can take any suitable form. For example, the voltage signal may be a variable voltage that can be converted to a numerical value by an analogue-to-digital converter, which may form part of controller 118, or can be a separate circuit. Alternatively, the voltage signal may be a numerical value that can directly be read by controller 118.

In yet other implementations, the voltage signal can be used directly without conversion to a numerical value, for example by taking the form of a variable voltage that directly controls one or more circuits that in turn control first TRIAC 126, second TRIAC 128, and third TRIAC 130.

Controller 118 may be configured to determine whether the determined voltage is within a first range of voltage values. This may include, for example, determining that the determined voltage is between a first lower threshold and a first upper threshold.

Alternatively, this may include determining that the determined voltage is below a threshold.

It may be advantageous, in at least some implementations, to have a clear distinction between upper and lower voltage ranges, to ensure proper configuration of heating elements and switching elements. For example, the hairstyling apparatus may be configured so as to not operate if the detected mains supply voltage or electrical energy source voltage is between the first upper threshold and the second lower threshold.

In alternative implementations, only a single threshold is used. Such a threshold may be, for example, between about 140 Vac and 176 Vac. For example, such a single threshold may be around 150 Vac.

Where hair straightener 100 is configured for use in nominally 120 Vac regions, the first lower threshold may be, for example, 85 Vac, and the first upper threshold may be, for example, 140 Vac.

When it is determined that the voltage is between the first and second lower thresholds, it may be concluded that hair straightener 100 has been plugged into a nominally 120 Vac mains voltage socket. First TRIAC 126, second TRIAC 128, and third TRIAC 130 are therefore controlled such that a total circuit resistance of the heating elements through which current flows is lower than a total circuit resistance of the heating elements through which current flows when the determined voltage exceeds the first range of voltage values.

In FIG. 3, controller 118 controls first TRIAC 126, second TRIAC 128, and third TRIAC 130 such that they do not conduct any current. This state may exist when, for example, hair straightener 100 is placed into a standby mode, in which first plate 122 is not heated.

Similarly, in FIG. 15, controller 118 controls first switch 1126, second switch 1128, and third switch 1130 such that they do not conduct any current. This state may exist when, for example, hair straightener 100 is placed into a standby mode, in which first plate 122 is not heated.

Referring to FIG. 4, controlling TRIACs 126, 128, and 130 when the voltage is between the first and second lower thresholds involves controlling first TRIAC 126 and second TRIAC 128 such that they conduct current, while maintaining third TRIAC 130 in the “off” state.

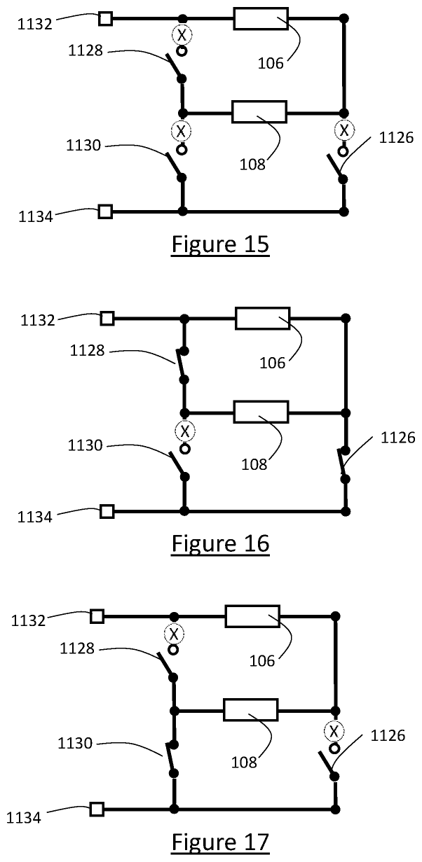

Similarly, referring to FIG. 16, controlling switches 1126, 1128, and 1130 when the voltage is between the first and second lower thresholds involves controlling first switch 1126 and second switch 1128 such that they conduct current, while maintaining third switch 1130 in the “off” state.

If first TRIAC 126 and second TRIAC 128 (or in FIG. 16, the first switch 1126 and the second switch 1128) are controlled such that they conduct, the net effect is that first heating element 106 is in parallel with second heating element 108. The net resistance of first heater 102 is therefore given by the equation for calculating parallel resistance:

$$1 / {R}_{T} = 1 / {R}_{106} + 1 / {R}_{108}$$

where R_{T} is the net resistance, R₁₂₆ is the resistance of first heating element 106, and R₁₀₈ is the resistance of second heating element 108.

Optionally, either or both of first and second TRIACs 126 and 128 may be controlled by controller 118 such that they modulate the current flowing through them. For example, controller 118 may control either or both of first and second TRIACs 126 and 128 in accordance with, for example, a burst/multi-cycle fire control scheme, a phase angle control scheme, a combination thereof, or any other suitable control scheme for controlling TRIACs. TRIAC control schemes are well known to those skilled in the art, and so will not be described in detail.

Optionally, modulation of either or both of first and second TRIACs 126 and 128 may be used to control the average amount of current flowing through either or both of first and second heating element 106 and 108, in order to achieve a desired overall heating performance. For example, in some implementations, it may be desirable to have first TRIAC 126 operate at a lower duty cycle than second TRIAC 128.

Alternatively, or in addition, suitable modulation schemes may be employed with either or both of first and second TRIACs 126 and 128 to optimise electromagnetic compatibility (EMC), including flicker, harmonics, and other conducted emissions.

Controller 118 may additionally, or alternatively, be configured to determine whether the determined voltage is within a second range of voltage values. This may include, for example, determining that the determined voltage is between a second lower threshold and a second upper threshold. Alternatively, this may include determining that the determined voltage is above a threshold. In that case, the threshold may be the first upper threshold, for example.

Where hair straightener 100 is configured for use in nominally 230 Vac regions, the second lower threshold may be, for example, 176 Vac, and the second upper threshold may be, for example, 264 Vac.

When it is determined that the voltage is between the first and second upper thresholds, it may be concluded that hair straightener 100 has been plugged into a nominally 230 Vac mains voltage socket. First TRIAC 126, second TRIAC 128, and third TRIAC 130 are therefore controlled such that a total circuit resistance of the heating elements through which current flows is higher than a total circuit resistance of the heating elements through which current flows when the determined voltage is below the first range of voltage values.

Referring to FIG. 5, controlling TRIACs 126, 128, and 130 when the voltage is between the first and second upper thresholds involves controlling third TRIAC 130 such that it conducts current, while maintaining first TRIAC 126 and second TRIAC 128 in the “off” state.

Similarly, referring to FIG. 17, controlling switches 1126, 1128, and 1130 when the voltage is between the first and second upper thresholds involves controlling third switch 130 such that it conducts current, while maintaining first switch 1126 and second switch 1128 in the “off” state.

If third TRIAC 130 (or on FIG. 17, the third switch 1130) is controlled such that it conducts, the net effect is that first heating element 106 is in series with second heating element 108. The net resistance of first heater 102 is therefore given by the equation for calculating series resistance:

$${R}_{T} = {R}_{106} + {R}_{108}$$

where R_{T} is the net resistance, R₁₀₆ is the resistance of first heating element 106, and R₁₀₈ is the resistance of second heating element 108.

Optionally, third TRIAC 130 may be controlled by controller 118 such that it modulates the current flowing through it. For example, controller 118 may control third TRIAC in accordance with, for example, a burst fire/multi-cycle control scheme, a phase angle control scheme, a combination thereof, or any other suitable control scheme for controlling TRIACs.

Turning to FIGS. 6 to 8, there is shown an alternative circuit comprising switching components in the forms of TRIACs that are connected with heating elements. The circuit shown in FIGS. 6 to 8 comprises a number of components corresponding with those of the circuit shown in FIGS. 3 to 5, and like reference signs have been used to indicate similar components.

In addition to first and second heating elements 106 and 108, and first, second, and third TRIACs 126, 128, and 130, the circuit shown in FIGS. 6 to 8 comprises a third heating element 138 and a fourth TRIAC 140 connected in series between live terminal 132 and neutral terminal 134.

FIG. 6 corresponds with FIG. 3, in that controller 118 maintains all TRIACs in their “off” state.

FIG. 7 corresponds with FIG. 4, in that the determined voltage suggests that hair straightener 100 has been plugged into a nominally 120 Vac mains voltage socket. Controller 118 controls first and second TRIACs 126 and 128 so that they conduct current, and keeps third TRIAC 130 turned “off”, such that first heating element 106 is effectively in parallel with second heating element 108. At the same time, controller 118 controls fourth TRIAC 140 so that it conducts current, such that third heating element 138 is also effectively in parallel with first heating element 106 and second heating element 108.

The net resistance of the circuit shown in FIG. 6 when first, second, and fourth TRIACs 126, 128, and 140 are conducting, while third TRIAC 130 is turned off, is given by the equation for calculating parallel resistance:

$$1 / {R}_{T} = 1 / {R}_{106} + 1 / {R}_{108} + 1 / {R}_{138}$$

where R_{T} is the net resistance, R₁₀₆ is the resistance of first heating element 106, R₁₀₈ is the resistance of second heating element 108, and R₁₃₈ is the resistance of third heating element 138.

FIG. 8 corresponds with FIG. 5, in that the determined voltage suggests that hair straightener 100 has been plugged into a nominally 230 Vac mains voltage socket. Controller 118 controls third TRIAC 130 so that it conducts current, and keeps first and second TRIACs 126 and 128 turned “off”, such that first heating element 106 is effectively in series with second heating element 108. At the same time, controller 118 controls fourth TRIAC 140 so that it conducts current, such that third heating element 138 is also effectively in parallel with the resistance of first heating element 106 in series with second heating element 108.

The net resistance of the circuit shown in FIG. 6 when first, second, and fourth TRIACs 126, 128, and 140 are conducting, while third TRIAC 130 is turned off, is given by the equation for calculating parallel resistance:

$$1 / {R}_{T} = 1 / ( {R}_{106} + {R}_{108} ) + 1 / {R}_{138}$$

Fourth TRIAC 140 may be controlled by controller 118 such that it modulates the current flowing through it. For example, controller 118 may control fourth TRIAC 140 in accordance with, for example, a burst fire/multi-cycle control scheme, a phase angle control scheme, a combination thereof, or any other suitable control scheme for controlling TRIACs.

Optionally, modulation of any or all of first, second, third, and fourth TRIACs 126, 128, 130, and 140 may be used to control the average amount of current flowing through any or all of first, second, and third heating elements 106, 108, and 138, in order to achieve a desired overall heating performance. For example, in some implementations, it may be desirable to have one or more of the TRIACs operate at a lower duty cycle than one or more of the other TRIACs.

Alternatively, or in addition, modulation of any or all of the TRIACs may be used to optimise electromagnetic compatibility (EMC), as described above.

Alternatively, or in addition, controller 118 may turn fourth TRIAC 140 “off”, reconfiguring the circuit of FIGS. 6 to 8 such that current does not flow through third heater 138. Controller 118 may turn fourth TRIAC 140 “off” at least partly in reliance on the determined voltage.

Turning to FIGS. 9 to 11, there is shown an alternative circuit comprising switching components in the forms of TRIACs, which are connected with heating elements. The circuit shown in FIGS. 6 to 8 comprises a number of components corresponding with those of the circuit shown in FIGS. 3 to 5, and like reference signs have been used to indicate similar components.

The circuit of FIGS. 9 to 11 includes a first heating element 142, a second heating element 144, a third heating element 146, a fourth heating element 148, a first TRIAC 150, a second TRIAC 152, a third TRIAC 154, and a fourth TRIAC 156.

First heating element 142 and first TRIAC 150 are connected in series between live terminal 132 and neutral terminal 134. Second heating element 144 and second TRIAC 152 are connected in series between live terminal 132 and neutral terminal 134. Third heating element 146 and third TRIAC 154 are connected in series between live terminal 132 and neutral terminal 134, and fourth heating element 148 and fourth TRIAC 156 are connected in series between live terminal 132 and neutral terminal 134. Electrically, each connected heating element and TRIAC pair is in parallel with all of the other heating element and TRIAC pairs.

Control terminals of first TRIAC 150, second TRIAC 152, third TRIAC 154, and fourth TRIAC 156 are connected to controller 118. As described in more detail below, controller 118 provides control signals to the TRIACs in order to reconfigure current flows through them, and hence through first heating element 142, second heating element 144, third heating element 146, and fourth heating element 148, at least partly in reliance on the determined voltage.

First and second heating elements 142 and 144 form a first set, and third and fourth heating elements 146 and 148 form a second set. In this context, “set” means a group of TRIACs that are controlled together by controller 118 at least partly in reliance on the determined voltage. Although this may mean that all TRIACs in each group are controlled identically, it may also be the case that individual TRIACs within a group are modulated differently at least partly in reliance on, for example, a user-selected mode or setting of hair straightener 100, and/or the determined voltage.

When it is determined that the voltage is between the first and second lower thresholds, it may be concluded that hair straightener 100 has been plugged into a nominally 120 Vac mains voltage socket. First, second, third, and fourth TRIACs 150, 152, 154, and 156 are therefore controlled such that a total circuit resistance of the heating elements through which current flows is lower than a total circuit resistance of the heating elements through which current flows when the determined voltage exceeds the first range of voltage values.

In FIG. 9, controller 118 controls all TRIACs such that they do not conduct any current. This state may exist when, for example, hair straightener 100 is placed into a standby mode, in which first plate 122 is not heated.

In FIG. 10, controlling TRIACs 150, 152, 154, and 156 when the voltage is between the first and second lower thresholds involves causing all TRIACs to conduct. The net effect is that all heating elements are in parallel with each other. The net resistance of first heater 102 is therefore given by the equation for calculating parallel resistance:

$$1 / {R}_{T} = 1 / {R}_{142} + 1 / {R}_{144} + 1 / {R}_{146} + 1 / {R}_{148}$$

where R_{T} is the net resistance, R₁₄₂ is the resistance of first heating element 142, R₁₄₄ is the resistance of second heating element 144, R₁₄₈ is the resistance of third heating element 146, and R₁₄₈ is the resistance of fourth heating element 148.

Optionally, any or all of TRIACs 150, 152, 154, and 156 may be controlled by controller 118 such that they modulate the current flowing through them. For example, controller 118 may control any or all of the TRIACs in accordance with, for example, a burst fire/multi-cycle control scheme, a phase angle control scheme, a combination thereof, or any other suitable control scheme for controlling TRIACs.

Optionally, modulation of any or all of the TRIACs may be used to control the average amount of current flowing through any or all of the TRIACs as a whole, in order to achieve a desired heating overall. For example, in some implementations, it may be desirable to have one or more TRIACs operate at a lower duty cycle than one or more of the other TRIACs.

Alternatively, or in addition, modulation of any or all of TRIACs 150, 152, 154, and 156 may be used to optimise electromagnetic compatibility (EMC), as described above.

When it is determined that the voltage is between the first and second upper thresholds, it may be concluded that hair straightener 100 has been plugged into a nominally 230 Vac mains voltage socket. TRIACs 150, 152, 154, and 156 are therefore controlled such that a total circuit resistance of the heating elements through which current flows is higher than a total circuit resistance of the heating elements through which current flows when the determined voltage is below the first range of voltage values.

Referring to FIG. 11, controlling TRIACs 150, 152, 154, and 156 when the voltage is between the first and second upper thresholds involves controlling first and second TRIACs 150, 152 such that they conduct current, while maintaining third and fourth TRIACs 154, 156 in the “off” state.

If first and second TRIACs 150, 152 are controlled such that they conduct, the net effect is that first heating element 142 is in parallel with second heating element 144. The net resistance of first heater 102 is therefore given by the equation for calculating parallel resistance:

$$1 / {R}_{T} = 1 / {R}_{142} + 1 / {R}_{144}$$

where R_{T} is the net resistance, R₁₄₂ is the resistance of first heating element 142, and R₁₄₄ is the resistance of second heating element 144.

Optionally, first TRIAC 150 and/or second TRIAC 152 may be controlled by controller 118 such that they modulate the current flowing through them. For example, controller 118 may control first TRIAC 150 and/or second TRIAC 152 in accordance with, for example, a burst fire/multi-cycle control scheme, a phase angle control scheme, a combination thereof, or any other suitable control scheme for controlling TRIACs.

Although the sets in FIGS. 9 to 11 do not overlap, the skilled person will appreciate that any number of heating elements may be in both the first and second sets. All that is required is that one of the sets includes at least one heating element that is not in the other set.

In other implementations, the one or more switching components can be controlled such that the current does not flow through at least one of the heating elements, at least partly in reliance on the determined voltage. For example, FIG. 12 shows a schematic of first heating element 158 connected in series with a first TRIAC 160, and a second heating element 162 connected in series with a second TRIAC 164. First heating element 158 and first TRIAC 160 are connected in series between live terminal 132 and neutral terminal 134. Second heating element 162 and second TRIAC 164 are connected between the junction between first heating element 158 and first TRIAC 160, and neutral terminal 134.

When the determined voltage is within the first range of voltage values, the one or more switching components are controlled such that at least one of the heating elements is bypassed, thereby to lower the total circuit resistance of the heating elements through which current flows. In FIG. 12, this means that controller 118 controls first TRIAC 160 such that it conducts, and maintains second TRIAC 164 in an “off” state. In this way, second heating element 162 is bypassed, which lowers the total circuit resistance.

When the determined voltage is within the second range of voltage values, controller 118 maintains first TRIAC 160 in an “off” state, and controls second TRIAC 164 such that it conducts. In this way, second heating element 162 is no longer bypassed. Current must now flow through both first heating element 158 and second heating element 162 in series, which results in a higher total circuit resistance compared to when the determined voltage is within the first range of voltage values.

The skilled person will appreciate that by arranging for different series- and/or parallel-connected heating elements to be selectively bypassed, different circuit resistances can be achieved, at least partly in reliance on the determined voltage.

Optionally, and in any implementation, any one or more individual TRIACs may additionally be controlled at least partly in reliance on a user-selected mode or setting of hair straightener 100. Such a mode or setting may be selected by a user by way of a user interface (not shown), comprising one or more switches, dials, sliders, buttons, touch surfaces, or other input elements provided as part of a user interface. The user interface may also provide feedback via one or more screens, lights, sounds, or the like.

For example, hair straightener 100 may have a “low” heat setting and a “high” heat setting. In addition to controlling the TRIACs in reliance on the current mains supply voltage, controller 118 may also control the TRIACs to increase or decrease the total power output of the heating elements, in dependence on the currently selected heat setting.

Other possible modes and settings will be apparent to the skilled person.

In any combination of switching components where there is a potential series path that does not pass through at least one heating element, it may be desirable to include a safety resistor to mitigate against accidental over-current events. Such events can be caused by, for example, hardware or software errors, and/or mains surge scenarios.

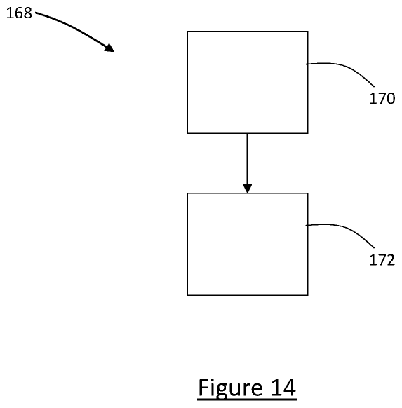

FIG. 13 is a schematic circuit that shows one example of such a safety resistor. The circuit of FIG. 13 corresponds with the circuit shown in FIGS. 3 to 5, and like reference signs have been used to indicate similar components. The difference is the inclusion of a further resistor 166 in series with the first, second and third TRIACs 126, 128, and 130, where there are no other resistances in this path between live rail 132 and neutral rail 134.

When third TRIAC 130 is off (e.g., in nominal 120 Vac mode), further resistor 166 is bypassed, and does not dissipate heat.

When third TRIAC 130 is on (e.g., in nominal 230 Vac mode), current passes through further resistor 166. Although further resistor 166 is placed adjacent third TRIAC 130, it can alternatively be positioned anywhere in the series connection of the first, second, and third TRIACs 126, 128, and 130.

The value of further resistor 166 may be selected so that it is capable of passing the required current without overheating. In this case, further resistor 166 can be designed around a relatively low operating temperature component.

Alternatively, further resistor 166 may comprise one or more heating elements forming part of the series circuit through the first, second and third TRIACs 126, 128, and 130. The amount of heat contributed by further resistor 166 (or resistors) may be taken into account when designing the thermal performance of the heating circuit as a whole.

For example, further resistor 166 may form part of the same physical resistive heating element as first heating element 106. In such an arrangement, first TRIAC 126 is electrically connected at a suitable point along the physical resistive heating element from which first heating element 106 and further resistor 166 are formed. This effectively divides the physical resistive heating element in first heating element 106 and further resistor 166. The connection is positioned to divide the total resistance of the physical resistive heating element between first heating element 106 and further resistor 166.

Further resistor 166 may alternatively be positioned at any other point in the electrical path from the positive or first rail to the neutral or second rail through the TRIACs.

The resistance of further resistor 166 is selected to limit the amount of current passing through the TRIACs in the event they are all turned on simultaneously. Limiting the current can reduce the chance of overcurrent damage to the TRIACs, and may also, or alternatively, give safety circuits time to operate.

Although the use of TRIACs has been described, the skilled person will appreciate that other switching components may be used, either by themselves, or in conjunction with other switching/modulating components like the previously-described TRIACs.

Examples of such switching components include, for example, insulated gate bipolar transistors (IGBTs), field effect transistors, mechanical relays, and any form of semiconductor switching or modulating device. An appropriate switching component type (or types) may be used, depending upon the way in which power is delivered to the heating element. For example, if the heating elements are supplied with DC current from a mains-powered DC power supply or an electrical energy source comprising a secondary battery, TRIACs will not be suitable, and IGBTs, field effect transistors or the like may be used instead.

Optionally, one or more hardware interlocks may be provided to offer an additional degree of protection against accidental switching of the switching components in response to a hardware failure or software error. For example, one or more hardware or semiconductor relays may be provided in-line with one or more of the switching components. The hardware or semiconductor relays may be controlled such that power is provided only to those switching components that will be switched by the switching components for a given determined voltage. Alternatively, or in addition, gate driving signals to the TRIACs may be interlocked, to prevent simultaneous firing of the TRIACs that would cause a short-circuit path between the positive and neutral rails.

Although the heating elements have been described as electrically resistive traces on a substrate, it will be appreciated that any suitable form of heating element(s) maybe be used, depending upon the particular application requirements. For example, the heating element(s) may comprise resistive wire or tape, wound or otherwise mounted to one or more substrates, formers, or supports. They may be configured to directly heat a component (such as first and second plates 122 and 124) or air (as required by, for example, a hairdryer). Alternatively, they may be configured to provide indirect heat (for example, the heating element may heat a diffuser, which in turns heats air as it passes).

Although the sensor has been described as a voltage sensor, the skilled person will appreciate that the term “sensor” is used broadly. Within the context of this application, “sensor” includes any combination of circuits and/or components that outputs one or more signals that are indicative of the voltage of the mains supply to which the hair styling apparatus is connected.

The signal being “indicative” of the voltage is also used broadly, and includes directly indicative and indirectly indicative. “Directly indicative” includes, for example, an arrangement in which the sensor outputs an analogue or digital signal indicative of a specific mains voltage or range of voltages. “Indirectly indicative” means that the output of the sensor is dependent upon the mains voltage, but does not directly represent it. For example, the sensor may measure current at a particular point, where the current varies based on the mains voltage. The sensor may measure a temperature of a particular component or components, where the temperature varies based on the mains voltage. It is not necessary to explicitly convert a current or temperature signal to voltage before using it.

Any desired number of additional heating elements may also be provided to suit a particular implementation's requirements. Such additional heating elements may be in series, parallel, or any combination thereof, with any other heating element or circuit comprising multiple heating elements.

Where the equation for parallel resistance is used herein, it assumes that all concerned TRIACs are conducting at the same time. Where fewer TRIACs are conducting, then the net instantaneous resistance will change correspondingly, and can be calculated in a known manner by the skilled person.

Turning to FIG. 14, there is shown a flowchart of a method 168 of controlling a hairstyling apparatus. The hairstyling apparatus comprises: a plurality of heating elements; a sensor for determining a voltage and/or current output of a mains power supply and outputting a signal, such as a voltage and/or current signal, indicative of the determined voltage and/or current output; and one or more switching components connected with the heating elements. For example, the hairstyling apparatus may take the form of any of the hairstyling apparatuses and alternatives described herein.

Method 168 comprises determining 170 the mains supply voltage, and controlling 172 the one or more switching components so as to reconfigure current flows through the plurality of heating elements at least partly in reliance on the determined voltage.

When the determined voltage is within a first range of voltage values, controlling of the one or more switching components may be such that a total circuit resistance of the heating elements through which current flows is lower than a total circuit resistance of the heating elements through which current flows when the determined voltage exceeds the first range of voltage values.

For example, when the determined voltage is within the first range of voltage values, the method may involve controlling the one or more switching components such that the current flows in parallel through at least a first and second heating element, thereby to lower the total circuit resistance of the heating elements through which current flows.

Moreover, when the determined voltage is within the first range of voltage values, the method may involve controlling the one or more switching components such that the current does not flow through at least one of the heating elements other than the first and second heating elements, thereby to lower the total circuit resistance of the heating elements through which current flows.

When the determined voltage is within the first range of voltage values, the one or more switching components may be controlled such that at least one of the heating elements is bypassed, thereby to lower the total circuit resistance of the heating elements through which current flows.

When the determined voltage is within a second range of voltage values, the method may involve controlling the one or more switching components such that a total circuit resistance of the heating elements through which current flows is higher than a total circuit resistance of the heating elements through which current flows when the determined voltage is lower than the second range of voltage values.

For example, when the determined voltage is within the second range of voltage values, the method may involve controlling the one or more switching components such that the current flows in series through at least a third and fourth of the heating elements, thereby to increase the total circuit resistance of the heating elements through which current flows.

Moreover, when the determined voltage is within the second range of voltage values, the method may involve controlling the one or more switching components such that the current flows through at least one of the heating elements through which current does not flow when the determined voltage is outside the second range of voltage values.

At least a plurality of the heating elements may be connected in parallel with each other, each parallel connected heating component being controllable by at least one of the switching components. In that case, the method may involve controlling, responsive to the signal, the switching elements so as to configure current flow through:
a first set of the heating elements; or
a second set of the heating elements different to the first set.

The hairstyling apparatus may comprise a controller connected to control the one or more switching components. In that case, the method may comprise receiving, at the controller, the signal from the sensor.

Although a hair straightener has been described, the skilled person will appreciate that the invention has application in other forms of hair styling apparatus, hair dryers, curling wands, hair straighteners of different forms and types compared to those described in detail above, or any other such apparatus used for styling hair with heat (and optionally moving air).

Although the invention has been described with reference to various implementations, the skilled person will appreciate that the invention may be embodied in many other forms, limited only by the scope of the claims.

1. A hairstyling apparatus comprising:
a plurality of heating elements;
a sensor for determining a voltage and/or current output of an electrical energy source, and outputting a signal indicative of the determined voltage and/or current output; and
one or more switching components connected with the heating elements;
wherein the hair-styling apparatus is configured such that the one or more switching components are controlled so as to reconfigure current flows through the plurality of heating elements at least partly in reliance on the signal.

2. The hairstyling apparatus of claim 1, wherein one or more of:
when the determined voltage is within a first range of voltage values, the one or more switching components are controlled such that a total circuit resistance of the heating elements through which current flows is lower than a total circuit resistance of the heating elements through which current flows when the determined voltage exceeds the first range of voltage values; and
when the determined voltage is within the first range of voltage values, the one or more switching components are controlled such that the current flows in parallel through at least a first and a second of the heating elements, thereby to lower the total circuit resistance of the heating elements through which current flows.

3. (canceled)

4. The hairstyling apparatus of claim 2, wherein, when the determined voltage is within the first range of voltage values, the one or more switching components are controlled such that the current does not flow through at least one of the heating elements other than the first and second heating elements, thereby to lower the total circuit resistance of the heating elements through which current flows.

5. The hairstyling apparatus of claim 2, wherein, when the determined voltage is within the first range of voltage values, the one or more switching components are controlled such that at least one of the heating elements is bypassed, thereby to lower the total circuit resistance of the heating elements through which current flows.

6. The hairstyling apparatus of claim 1, wherein one or more of:
when the determined voltage is within a second range of voltage values, the one or more switching components are controlled such that a total circuit resistance of the heating elements through which current flows is higher than a total circuit resistance of the heating elements through which current flows when the determined voltage is lower than the second range of voltage values; and
when the determined voltage is within the second range of voltage values, the one or more switching components are controlled such that the current flows in series through at least a third and fourth of the heating elements, thereby to increase the total circuit resistance of the heating elements through which current flows.

7. (canceled)

8. The hairstyling apparatus of claim 6, wherein, when the determined voltage is within the second range of voltage values, the one or more switching components are controlled such that the current flows through at least one of the heating elements through which current does not flow when the determined voltage is outside the second range of voltage values.

9. The hairstyling apparatus of claim 6, wherein, when the determined voltage is within the second range of voltage values, the one or more switching components are controlled such that current flows through at least one of the heating elements through which current does not flow when the determined voltage is lower than the second range of voltage values, thereby to lower the total circuit resistance of the heating elements through which current flows.

10. The hairstyling apparatus of claim 1, wherein at least a plurality of the heating elements are connected in parallel with each other, each parallel connected heating element being controllable by at least one of the switching components, the hair-styling apparatus being configured such that the one or more switching components are controlled responsive to the signal, so as to configure current flow through:
a first set of the heating elements; or
a second set of the heating elements different to the first set.

11. The hairstyling apparatus of claim 1, wherein at least two of the plurality of heating elements are connected to the switching components via a shared electrical connection.

12. The hairstyling apparatus of claim 1, wherein the hairstyling apparatus comprises a first heater and a second heater each or the first heater and second heater comprising a respective plurality of heating elements and the hairstyling apparatus is configured such that the first heater is controllable independently of the second heater.

13. The hairstyling apparatus of claim 1, wherein the hairstyling apparatus comprises a first heater and a second heater each of the first heater and second heater comprising a respective plurality of heating elements and the hairstyling apparatus is configurable such that the one or more switching components are controlled so as to reconfigure current flows through the plurality of heating elements such that the power delivered to the first heater is different to the power delivered to the second heater.

14. The hairstyling apparatus of claim 1, wherein the hairstyling apparatus comprises a first heater and a second heater each of the first heater and second heater comprising a respective plurality of heating elements and the hairstyling apparatus is reconfigurable such that a total circuit resistance of the heating elements of the first heater through which current flows is different to a total circuit resistance of heating elements of the second heater.

15. The hairstyling apparatus of claim 1, wherein the hairstyling apparatus comprises a first heater and a second heater each of the first heater and second heater comprising a respective plurality of heating elements and the hairstyling apparatus is configurable such that the one or more switching components are controlled such that the current flows in parallel through at least a first and a second heating elements of one of the first or second heater, while the current flows in series through at least a first and a second heating elements of the other of the first or second heater.

16. A method of controlling a hairstyling apparatus, the hairstyling apparatus comprising:
a plurality of heating elements;
a sensor for determining a voltage and/or current output of the electrical energy source, and outputting a signal indicative of the determined voltage and/or current output; and
one or more switching components connected with the heating elements;
the method comprising controlling the one or more switching components so as to reconfigure current flows through the plurality of heating elements at least partly in reliance on the signal.

17. The method of claim 16, comprising one or more of:
when the determined voltage is within a first range of voltage values, controlling the one or more switching components such that a total circuit resistance of the heating elements through which current flows is lower than a total circuit resistance of the heating elements through which current flows when the determined voltage exceeds the first range of voltage values;
when the determined voltage is within the first range of voltage values, controlling the one or more switching components such that the current flows in parallel through at least a first and second of the heating elements, thereby to lower the total circuit resistance of the heating elements through which current flows; and
when the determined voltage is within the first range of voltage values, controlling the one or more switching components such that the current does not flow through at least one of the heating elements other than the first and second heating elements, thereby to lower the total circuit resistance of the heating elements through which current flows.

18. (canceled)

19. (canceled)

20. The method of claim 17, comprising:
when the determined voltage is within the first range of voltage values, controlling the one or more switching components such that at least one of the heating elements is bypassed, thereby to lower the total circuit resistance of the heating elements through which current flows.

21. The method of claim 16, wherein one or more of:
when the determined voltage is within a second range of voltage values, controlling the one or more switching components such that a total circuit resistance of the heating elements through which current flows is higher than a total circuit resistance of the heating elements through which current flows when the determined voltage is lower than the second range of voltage values; and
when the determined voltage is within the second range of voltage values, controlling the one or more switching components such that the current flows in series through at least a third and fourth of the heating elements, thereby to increase the total circuit resistance of the heating elements through which current flows.

22. (canceled)

23. The method of claim 21, comprising:
when the determined voltage is within the second range of voltage values, controlling the one or more switching components such that the current flows through at least one of the heating elements through which current does not flow when the determined voltage is outside the second range of voltage values.

24. The method of claim 21, wherein at least a plurality of the heating elements are connected in parallel with each other, each parallel connected heating element being controllable by at least one of the switching components, the method comprising controlling, responsive to the signal, the switching elements so as to configure current flow through:
a first set of the heating elements; or
a second set of the heating elements different to the first set.

25. The method of claim 16, wherein the hairstyling apparatus comprises a first heater comprising a plurality of heating elements, a second heater comprising a plurality of heating elements, the method comprising controlling the first heater independently of the second heater.
